(19) United States
(12) Patent Application Publication
(10) Pub. No.: US 2026/0178917 A1
(43) Pub. Date: Jun. 25, 2026

(54) INFORMATION PROCESSING METHOD, INFORMATION PROCESSING DEVICE, AND PROGRAM

(71) Applicant: Panasonic Intellectual Property Management Co., Ltd., Osaka (JP)

(72) Inventor: WATARU ARAKIZEKI, Osaka (JP)

(21) Appl. No.: 19/539,105

(22) Filed: Feb. 13, 2026

Related U.S. Application Data
(63) Continuation of application No. PCT/JP2024/039921, filed on Nov. 11, 2024.

(30) Foreign Application Priority Data
Jan. 17, 2024 (JP) 2024-005100

(51) Int. Cl. G06N 3/084; G06F 18/21; G06N 3/045

(52) U.S. Cl. CPC G06N 3/084; G06F 18/217; G06N 3/045

(57) ABSTRACT

A learned model is trained to acquire a data row including a plurality of pieces of data regarding a product (S110), set target data among the plurality of acquired pieces of data as an inference target, acquire inference data output by inputting the plurality of pieces of data into an inference model, and a degree of contribution of each of the plurality of pieces of data to the inference data, and output the degree of contribution of the plurality of acquired pieces of data (S113). The inference model is a learned model trained to set, as an inference target, learning target data among a plurality of pieces of learning data included in each of a plurality of learning data rows, output the learning target data inferred from one or more pieces of learning data obtained in a step upstream of a step in which the learning target data is obtained, and output a degree of contribution of each of the one or more pieces of learning data to the learning target data to be output, when the plurality of learning data rows regarding the product in a plurality of steps are input to the inference model.

### TECHNICAL FIELD

The present disclosure relates to an information processing method, an information processing device, and a program.

### BACKGROUND ART

A method for inferring a variable such as a sensor value (for example, temperature, pressure, or the like) acquired in a step of manufacturing a product in a factory or the like using mechanism learning (also simply referred to as learning) having an attention mechanism is known (see PTL 1). The sensor value may be a sensor value that contributes to occurrence of a defect in a factory. Note that “inference” may be paraphrased as “estimation”.

As a conventional technique relating to learning, there is a technique of detecting an abnormality in a specific element among a plurality of pieces of data (see PTL 1).

In learning processing for abnormality detection, regression, classification, or the like for a single inference target, it may not be temporally realistic to exhaustively infer relationships among a large number of variables in an entire factory.

In the field of natural language processing, a method of comprehensively learning a mutual relationship of words as variables in sentences is known (see Non-Patent Literature 1). In this method, a learning method is proposed in which an input is randomly masked (in other words, concealed) and an original value (in other words, the value before being masked) of a masked portion is inferred.

### Citation List

### Patent Literature

PTL 1: Unexamined Japanese Patent Publication No. 2020-149601

### Non-Patent Literature

Non-Patent Literature 1: Jacob Devlin et al, “BERT: Pre-training of Deep Bidirectional Transformers for Language Understanding”, [online], [searched on December 1, 2023], Internet <URL: https://arxiv.org/abs/1810.04805>

### SUMMARY OF THE INVENTION

The present disclosure provides an information processing method and the like that can improve the efficiency of learning for inference.

An information processing method according to one aspect of the present disclosure includes: acquiring a data row including a plurality of pieces of data that are regarding a product and obtained in a plurality of steps in manufacturing of the product; setting target data among the plurality of pieces of acquired data as an inference target, acquiring inference data output by inputting the plurality of pieces of data to an inference model, and a degree of contribution of each of the plurality of pieces of data to the inference data; and outputting the degree of contribution of each of the plurality of pieces of acquired data, wherein the inference model is a learned model trained to set, as an inference target, learning target data among a plurality of pieces of learning data included in each of a plurality of learning data rows, output the learning target data inferred from one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

These comprehensive or specific aspects may be achieved by a system, a device, an integrated circuit, a computer program, or a recording medium such as a computer-readable CD-ROM, and may be achieved by any combination of the system, the device, the integrated circuit, the computer program, and the recording medium.

The information processing method according to the present disclosure can improve the efficiency of learning for inference.

### BRIEF DESCRIPTION OF THE DRAWINGS

FIG. 1 is a schematic diagram illustrating an example of a data analysis system according to an exemplary embodiment.

FIG. 2 is a configuration diagram illustrating a hardware configuration of a data analysis device according to the exemplary embodiment.

FIG. 3 is an explanatory diagram illustrating an example of a data set according to the exemplary embodiment.

FIG. 4 is an explanatory diagram illustrating an example of step order data according to the exemplary embodiment.

FIG. 5 is an explanatory diagram illustrating an example of the order of steps according to the exemplary embodiment.

FIG. 6 is an explanatory diagram illustrating an example of variable explanation data according to the exemplary embodiment.

FIG. 7 is a configuration diagram illustrating a configuration of the data analysis device according to the exemplary embodiment.

FIG. 8 is a flowchart illustrating processing of the data analysis device according to the exemplary embodiment.

FIG. 9A is a first flowchart illustrating processing of creating input data for learning and processing of selecting a learning target according to the exemplary embodiment.

FIG. 9B is a second flowchart illustrating the processing of creating input data for learning and the processing of selecting a learning target according to the exemplary embodiment.

FIG. 10 is an explanatory diagram illustrating a first example of a list according to the exemplary embodiment.

FIG. 11 is an explanatory diagram illustrating a second example of the list according to the exemplary embodiment.

FIG. 12 is an explanatory diagram illustrating an example of a reachable step list according to the exemplary embodiment.

FIG. 13 is a flowchart illustrating data analysis processing according to the exemplary embodiment.

### DESCRIPTION OF EMBODIMENT

### Underlying knowledge on the present disclosure

In learning for inference of a mask portion in Non-Patent Literature 1, all combinations using a plurality of pieces of data are allowed.

On the other hand, among all combinations using a plurality of pieces of data such as a plurality of sensor values acquired in a step of manufacturing a product in a factory or the like, a combination in which one piece of data does not affect the other piece of data is present. For example, in general, a result of a subsequent step (in other words, downstream step) among a plurality of steps relating to manufacturing of a product does not affect a result of a step (in other words, upstream step) prior to the step.

Therefore, in a case of using learning in which all combinations using a plurality of pieces of data are allowed as in the learning of the mask portion in Non-Patent Literature 1, the efficiency of learning may decrease, and more specifically, the learning may cause a decrease in the accuracy of inference or an increase in learning time. This is because all the combinations using the plurality of pieces of data actually include a combination in which one piece of data does not affect the other piece of data, and such a combination does not contribute to convergence of a parameter included in the model.

Therefore, the present disclosure provides an information processing method and the like that can improve the efficiency of learning for inference.

Hereinafter, an invention obtained from the disclosed contents of the present specification will be exemplified, and effects and the like obtained from the invention will be described.

(1) An information processing method including: acquiring a data row including a plurality of pieces of data that are regarding a product and obtained in a plurality of steps in manufacturing of the product; setting target data among the plurality of pieces of acquired data as an inference target, and acquiring inference data output by inputting the plurality of pieces of data to an inference model, and a degree of contribution of each of the plurality of pieces of data to the inference data; and outputting the degree of contribution of each of the plurality of pieces of acquired data, wherein the inference model is a learned model trained to set, as an inference target, learning target data among a plurality of pieces of learning data included in each of a plurality of learning data rows, output the learning target data inferred from one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

According to the above-described aspect, the inference of the target data from the data obtained in the step upstream of the step in which the target data is obtained. In other words, the inference of the target data from the data obtained in the step in which the target data is obtained or data obtained in a step downstream of the step is suppressed. Actually, it is assumed that data obtained in a certain step is affected by a step upstream of the step, but is not affected by a step downstream of the step. Therefore, if the data obtained in the step downstream of the step in which the target data is obtained is included in the basis of the inference, the efficiency of learning may decrease. According to the above-described aspect, there is an effect that it is possible to suppress such a decrease in the efficiency of learning. Then, since a degree of contribution to a result of inference of each of the plurality of pieces of data can be output using the learned model obtained by learning in which a decrease in learning efficiency is suppressed, the efficiency of outputting the degree of contribution can be improved. As described above, according to the information processing method, the efficiency of learning for inference can be improved.

(2) The information processing method according to (1), wherein the inference model is a machine learning model using an attention mechanism, and the degree of contribution of each of the plurality of pieces of data to the inference data is a weight of each of the plurality of pieces of data for the inference data and is output by the attention mechanism.

According to the above-described aspect, by using the weights output by the attention mechanism as the degrees of contribution, the efficiency of learning for inference can be more easily improved.

(3) An information processing method including: acquiring a plurality of learning data rows including a plurality of pieces of learning data that are regarding a product and obtained in a plurality of steps in manufacturing of the product; and training an inference model using the plurality of acquired learning data rows, wherein in the training of the inference model, the inference model is trained to set, as an inference target, learning target data among a plurality of pieces of learning data included in each of the plurality of learning data rows, infer the learning target data from one or more pieces of learning data obtained in a step upstream of a step in which the learning target data is obtained, and infer a degree of contribution of each of the one or more pieces of learning data to the learning target data to be inferred.

According to the above-described aspect, the inference of the target data from the data obtained in the step upstream of the step in which the target data is obtained. In other words, the inference of the target data from the data obtained in the step in which the target data is obtained or data obtained in a step downstream of the step is suppressed. Actually, it is assumed that data obtained in a certain step is affected by a step upstream of the step, but is not affected by a step downstream of the step. Therefore, if the data obtained in the step downstream of the step in which the target data is obtained is included in the basis of the inference, the efficiency of learning may decrease. According to the above-described aspect, there is an effect that it is possible to suppress such a decrease in the efficiency of learning. As described above, according to the information processing method, the efficiency of learning for inference can be improved.

(4) The information processing method according to (3), wherein the plurality of learning data rows include an identifier of the step in which each of the plurality of pieces of learning data is obtained, and in the training of the inference model, the one or more pieces of learning data are specified by using order information indicating an order of the plurality of steps to exclude (a) a step in which the learning target data is obtained among the plurality of pieces of learning data and (b) a step downstream of the step in which the learning target data is obtained, and the inference model is trained using the specified one or more pieces of learning data.

According to the above-described aspect, by using the order information to exclude the step in which the learning target data is obtained and the step downstream of the step, the learning data to be used for training of the inference model can be more easily specified from the plurality of pieces of learning data. As a result, the efficiency of learning for inference can be more easily improved.

(5) The information processing method according to (3) or (4), wherein the inference model is a machine learning model using an attention mechanism, and the degree of contribution of each of the one or more pieces of learning data to the learning target data to be inferred is a weight of each of the plurality of pieces of learning data for the learning target data to be inferred and is output by the attention mechanism.

According to the above-described aspect, by using the weights output by the attention mechanism as the degrees of contribution, the efficiency of learning for inference can be more easily improved.

(6) An information processing device including: an acquisition unit that acquires a data row including a plurality of pieces of data that are regarding a product and obtained in a plurality of steps in manufacturing of the product; and an inference unit that sets target data among the plurality of pieces of acquired data as an inference target, acquires inference data output by inputting the plurality of pieces of data to an inference model, and a degree of contribution of each of the plurality of pieces of data to the inference data, and outputs the degree of contribution of each of the plurality of pieces of acquired data, wherein the inference model is a learned model trained to set, as an inference target, learning target data among a plurality of pieces of learning data included in each of a plurality of learning data rows, output the learning target data by inputting one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

According to the above-described aspect, an effect similar to that of the information processing method is achieved.

(7) An information processing device including: an acquisition unit that acquires a plurality of learning data rows including a plurality of pieces of learning data that are regarding a product and obtained in a plurality of steps in manufacturing of the product; and a learning unit that trains an inference model using the plurality of acquired learning data rows regarding the product in the plurality of steps, wherein in the training of the inference model, the learning unit trains the inference model to set, as an inference target, learning target data among a plurality of pieces of learning data included in each of the plurality of learning data rows, and infer the learning target data and infer a degree of contribution of each of the one or more pieces of learning data to the learning target data to be inferred, when one or more pieces of learning data obtained in a step upstream of a step in which the learning target data is obtained are input to the inference model.

According to the above-described aspect, an effect similar to that of the information processing method is achieved.

(8) A program for causing a computer to execute the information processing method according to (1).

According to the above-described aspect, an effect similar to that of the information processing method is achieved.

(9) A program for causing a computer to execute the information processing method according to (3).

According to the above-described aspect, an effect similar to that of the information processing method is achieved.

These comprehensive or specific aspects may be achieved by a system, a device, an integrated circuit, a computer program, or a recording medium such as a computer-readable CD-ROM, and may be achieved by any combination of the system, the device, the integrated circuit, the computer program, or the recording medium.

Hereinafter, exemplary embodiments will be described with reference to the drawings.

### First exemplary embodiment

### Hardware configuration

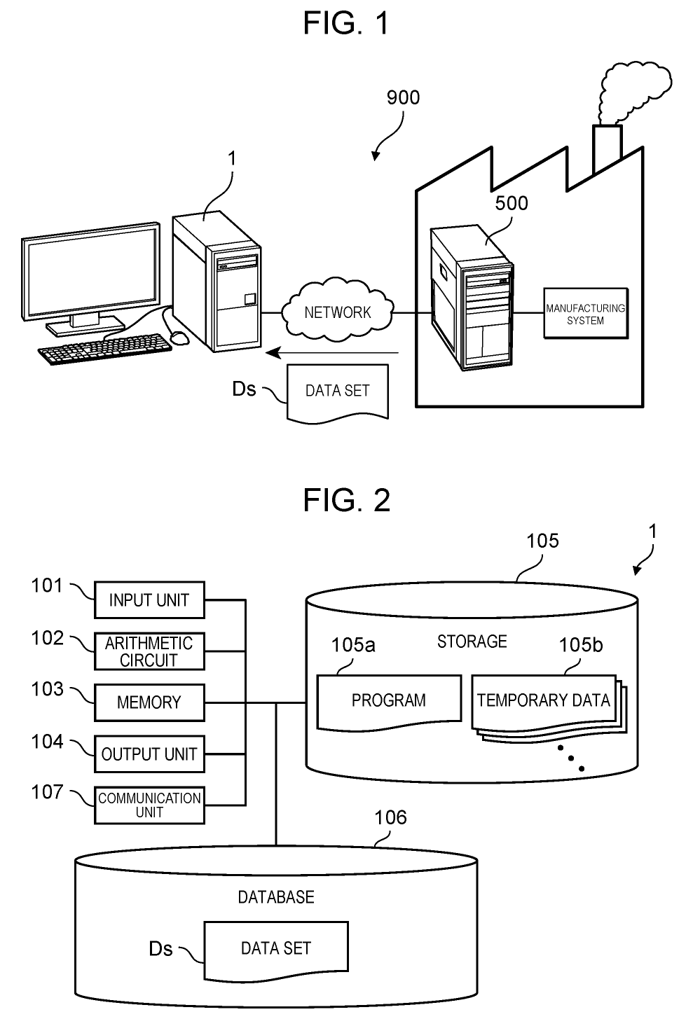

FIG. 1 is a schematic diagram illustrating an example of data analysis system 900 according to the present exemplary embodiment.

Data analysis system 900 according to the present exemplary embodiment includes data analysis device 1 and manufacturing management device 500.

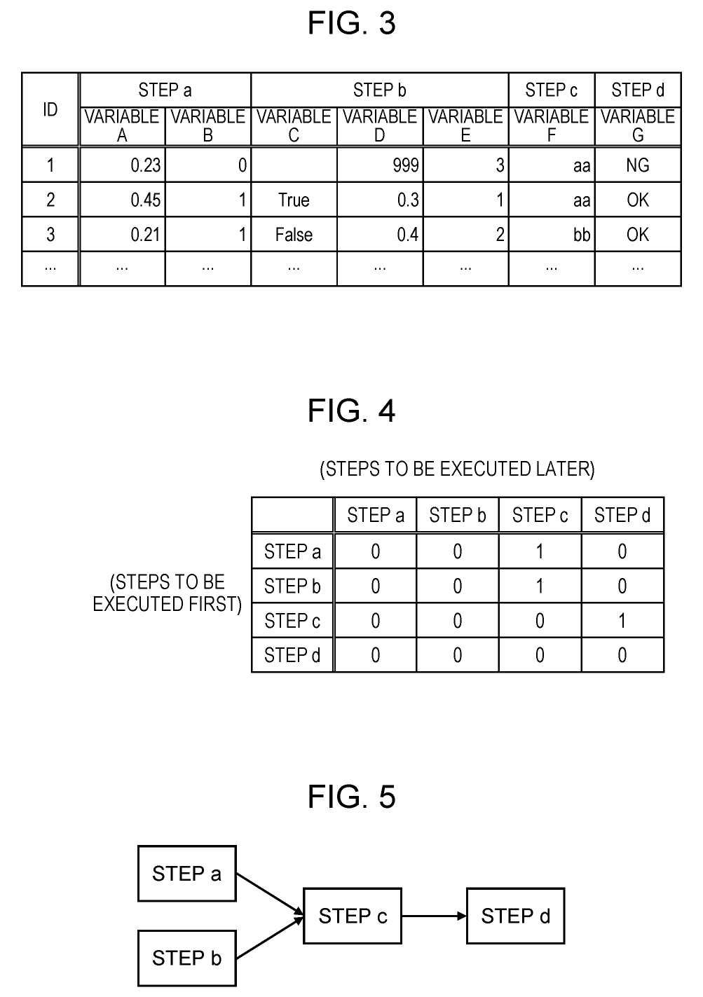

Manufacturing management device 500 is, for example, a device that is installed in a manufacturing factory and manages a manufacturing system for manufacturing a product. Manufacturing management device 500 transmits data set Ds obtained by the manufacturing system to data analysis device 1 via a network such as the Internet. Note that, details of data set Ds will be described later with reference to FIGS. 3 and 4.

Data analysis device 1 includes a personal computer or the like, and receives data set Ds from manufacturing management device 500 described above. Then, data analysis device 1 according to the present exemplary embodiment performs calculation for training a model for performing, for each piece of data, inference using data other than the data based on data set Ds. In other words, data analysis device 1 performs calculation for training a model for inferring each piece of data included in data set Ds from a variable other than the data.

FIG. 2 is a configuration diagram illustrating a hardware configuration of data analysis device 1 according to the present exemplary embodiment.

Data analysis device 1 includes input unit 101, arithmetic circuit 102, memory 103, output unit 104, storage 105, database 106, and communication unit 107.

Communication unit 107 communicates with a device outside data analysis device 1. This communication may be wired communication or wireless communication. The wireless communication method may be Wi-Fi (registered trademark), Bluetooth (registered trademark), or ZigBee (registered trademark), or may be another method. For example, communication unit 107 communicates with manufacturing management device 500 and receives data set Ds from manufacturing management device 500.

Input unit 101 has a function as a human machine interface (HMI) that receives an input operation by a user, and includes, for example, a keyboard, a mouse, a touch sensor, a touch pad, and the like.

Output unit 104 includes a display that displays an image, characters, or the like, and the display is, for example, a liquid crystal display, a plasma display, an organic electro-luminescence (EL) display, or the like. Note that, output unit 104 may include a printer that prints an image, characters, or the like, and may have a function of storing data output from arithmetic circuit 102 into storage 105 in a file format.

Storage 105 stores program (that is, computer program) 105a in which each command to arithmetic circuit 102 is described. In addition, each piece of temporary data 105b temporarily generated by processing of arithmetic circuit 102 may be stored in storage 105. Note that, such storage 105 is a non-volatile recording medium, and is, for example, a magnetic storage device such as a hard disk, an optical disc, a semiconductor memory, or the like. Note that, program 105a is provided to data analysis device 1 via, for example, a removable medium or a network, and is stored in storage 105. The removable medium is, for example, a compact disc read only memory (CD-ROM), a flash memory, or the like. Thus, communication unit 107 may include an interface that reads program 105a in the removable medium.

Program 105a read and loaded by arithmetic circuit 102 is temporarily stored in memory 103. Such memory 103 is, for example, a volatile random access memory (RAM).

Arithmetic circuit 102 is a circuit that executes program 105a loaded in memory 103, and is, for example, a central processing unit (CPU), a graphics processing unit (GPU), or the like. Arithmetic circuit 102 may use each piece of temporary data 105b stored in storage 105 when program 105a is executed.

Similarly to storage 105, database 106 is a non-volatile recording medium, and is, for example, a magnetic storage device such as a hard disk, an optical disc, a semiconductor memory, or the like. For example, arithmetic circuit 102 acquires data set Ds from manufacturing management device 500 via the network and communication unit 107, and stores data set Ds into database 106.

Note that, in the present exemplary embodiment, storage 105 and database 106 are different recording media, but storage 105 and database 106 may be constituted as one recording medium including the storage and the database.

### Data set

FIG. 3 is an explanatory diagram illustrating an example of data set Ds according to the present exemplary embodiment.

Data set Ds illustrated in FIG. 3 is a raw data set transmitted from manufacturing management device 500. Data set Ds can include, for example, a plurality of pieces of data indicating setting values indicating physical properties or conditions in a manufacturing process of the above-described manufacturing system, sensor values acquired by measurement in the manufacturing process, the quality of a product produced by the manufacturing process, and the like.

Specifically, data set Ds includes, for each Identifier (ID) that is an identifier indicating an individual product, step names of each of a plurality of steps a, b, c, and d in manufacturing of the product, variable names of each of a plurality of variables A, B, C, D, E, F, and G, and these variables as data. The plurality of variables A to G indicate, for example, a force, a voltage, a current, a temperature, an irradiation time, a dimension, a feature vector obtained from an inspection image, or the like.

Note that the data may be any data as long as the data indicates at least one of a character, a character string, a numerical value, a numerical value string, and a special symbol separately defined and indicating a lost value. A step name of each of the plurality of variables is arranged in the first row of data set Ds, and a variable name of each of the variables is arranged in the second row of data set Ds. A data row having data of a plurality of variables is arranged in each of the third and subsequent rows of data set Ds. As for the step names, different step names are given to actually different steps. Further, regarding the variables, different variable names are given to actually different variables (for example, variables for which sensors or the like as information sources are different).

FIG. 4 is an explanatory diagram illustrating an example of step order data Do according to the present exemplary embodiment. FIG. 5 is an explanatory diagram illustrating an example of the order of steps according to the present exemplary embodiment.

In FIG. 5, figures indicating the plurality of steps a, b, c, and d are connected by arrows. Each of the arrows indicates the order in which a step connected at the end point of the arrow is executed after the execution of a step connected at the start point of the arrow is completed.

Step order data Do illustrated in FIG. 4 is data indicating the order of the plurality of steps illustrated in FIG. 5. Step order data Do is an example of order information indicating an order of a plurality of steps.

In FIG. 4, as an example of step order data Do, “steps to be executed first” are illustrated side by side in a vertical direction, and steps to be executed after the “steps to be executed first” are illustrated side by side in a horizontal direction as “steps to be executed later”. In a case where step 2 is to be executed next to step 1 in manufacturing of a product, 1 is illustrated at a position where the “step to be executed first” is step 1 and the “step to be executed later” is step 2. In addition, in a case where step 2 is not to be executed next to step 1, 0 is illustrated at a position where the “step to be executed first” is step 1 and the “step to be executed later” is step 2.

It can also be said that step order data Do illustrated in FIG. 4 is an adjacency matrix for a graph (more specifically, a directed graph) indicating the order of the plurality of steps illustrated in FIG. 5.

For example, as illustrated in FIG. 5, step order data Do in a case where the steps proceed in the order where step c is executed next to step a, step c is executed next to step b, and step d is executed next to step c is illustrated in FIG. 4. Step c in the present exemplary embodiment is a step of processing a product by combining components obtained in step a and step b.

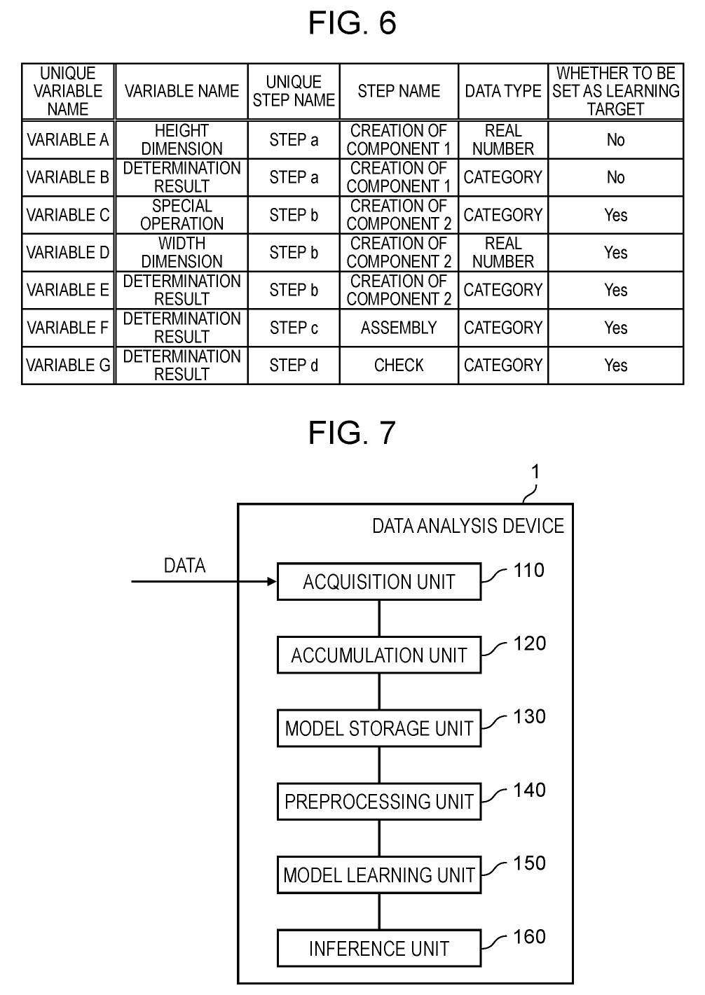

FIG. 6 is a diagram illustrating an example of variable explanation data De in the present exemplary embodiment.

For each of all the variables A, B, C, D, E, F, and G, a variable name (in other words, a variable name that may be duplicated), a unique step name, a step name (in other words, a step name that may be duplicated), a data type of the variable, and information indicating whether to be set as a learning target are stored in variable explanation data De illustrated in FIG. 6.

The information indicating whether to be set as a learning target indicates whether the variable is to be set as a learning target in entire learning processing by data analysis device 1. For example, a variable for which information indicating whether to be set as a learning target indicates “Yes” is a variable to be set as a learning target by data analysis device 1, and a variable for which information indicating whether to be set as a learning target indicates “No” is a variable not to be set as a learning target by data analysis device 1.

Note that the variable explanation data may not include variable names that may be duplicated or step names that may be duplicated. In addition, in a case where all the variables are set as learning targets, the variable explanation data may not include information indicating whether the variables are to be set as learning targets. In a case where the step names and the variable names are indicated in the data set, the step names may not be included in the variable explanation data. In a case where the step names are included in the variable explanation data, the step names may not be included in the data set.

### Configuration of data analysis device

A configuration and processing of data analysis device 1 according to the present exemplary embodiment will be described.

Data analysis device 1 acquires learning data rows including a plurality of pieces of learning data that are regarding a product and obtained in a plurality of steps in manufacturing of the product, and trains an inference model using the plurality of acquired learning data rows. In the training of the inference model, the inference model is trained to set, as an inference target, learning target data among a plurality of pieces of learning data included in each of the plurality of learning data rows, infer the learning target data from one or more pieces of learning data obtained in a step upstream of a step in which the learning target data is obtained, and infer a degree of contribution of each of one or more pieces of learning data to the learning target data to be inferred.

The plurality of learning data rows may include an identifier of the step in which each of the plurality of pieces of learning data is obtained. Then, in the training of the inference model, the one or more pieces of learning data may be specified by using the order information indicating the order of the plurality of steps to exclude (a) a step in which the learning target data is obtained among the plurality of pieces of learning data and (b) a step downstream of the step in which the learning target data is obtained, and the inference model may be trained using the specified one or more pieces of learning data.

The inference model may be a machine learning model using an attention mechanism. The degree of contribution of each of the one or more pieces of learning data to the learning target data to be inferred may be a weight of each of the plurality of pieces of learning data for the learning target data to be inferred and may be output by the attention mechanism.

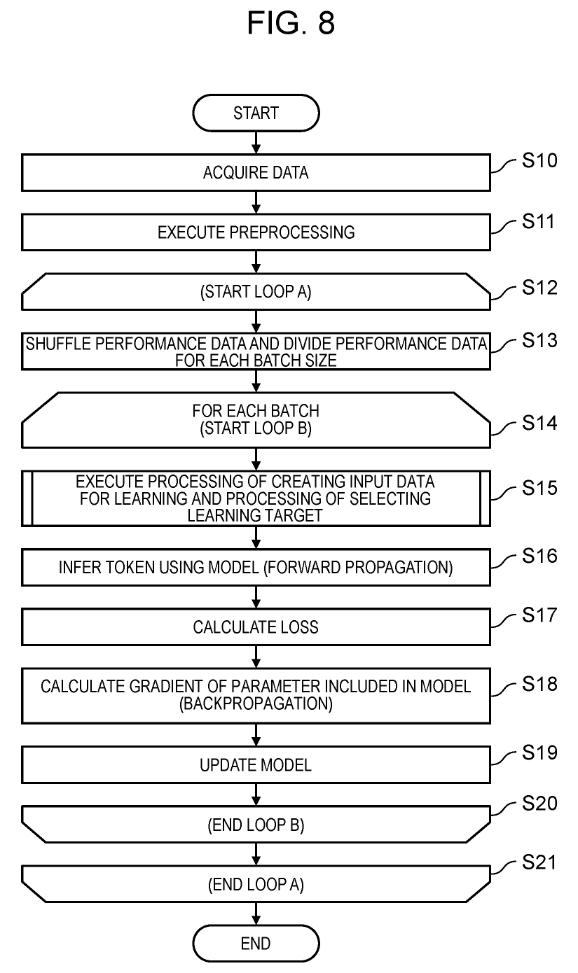

A configuration and processing of data analysis device 1 according to the present exemplary embodiment will be described with reference to FIGS. 7 and 8.

FIG. 7 is a configuration diagram illustrating a functional configuration of data analysis device 1 according to the present exemplary embodiment.

As illustrated in FIG. 7, data analysis device 1 includes acquisition unit 110, accumulation unit 120, model storage unit 130, preprocessing unit 140, model learning unit 150, and inference unit 160.

Acquisition unit 110 acquires performance data, step order data, and variable explanation data. Acquisition unit 110 acquires data set Ds (see FIG. 3) as an example of the performance data, acquires step order data Do (see FIG. 4) as the step order data, and acquires variable explanation data De (see FIG. 6) as the variable explanation data. Acquisition unit 110 can acquire the data using communication unit 107.

Accumulation unit 120 stores the data (that is, the performance data, the step order data, and the variable explanation data) acquired by acquisition unit 110. Accumulation unit 120 can store the data acquired by acquisition unit 110 into database 106.

The model storage unit 130 stores the machine learning model (for example, a transformer) using the attention mechanism. The machine learning model may be initialized by a random number or may be learned in advance. The machine learning model is, for example, a neural network that generates feature attention using the attention mechanism, and may be configured by a convolutional neural network (CNN) or the like.

The attention mechanism is a function using a third-order tensor K of the number of dimensions (B, L, D1), a third-order tensor Q of the number of dimensions (B, L, D1), and a third-order tensor V of the number of dimensions (B, L, D2) as inputs. The attention mechanism calculates similarity between the tensor K and the tensor Q as B similarity matrices of the number of dimensions (B, L, L), and treats the calculated similarity matrices as a weight of attention. In this case, B represents a batch size, L represents the number of variables (= the number of tokens per data row), and each of D1 and D2 represents the number of dimensions determined by the model. Note that it can be said that the weight of attention indicates a degree of contribution of the data used for the inference to the inferred data.

The machine learning model stored in model storage unit 130 can be updated by model learning unit 150.

Preprocessing unit 140 performs conversion processing on the performance data stored in accumulation unit 120 based on data types of the variables described in the variable explanation data. The conversion processing may be, for example, conversion of bringing a distribution of real numerical values close to a normal distribution, or processing of dimension reduction on a vector.

Model learning unit 150 updates the machine learning model stored in model storage unit 130 by learning. The learning is performed based on the performance data, the step order data, and the variable explanation data stored in accumulation unit 120.

Model learning unit 150 acquires, for example, data set Ds (see FIG. 3) as the performance data stored in accumulation unit 120, step order data Do (see FIG. 4), and variable explanation data De (see FIG. 6).

Model learning unit 150 repeats the following processing one or more times.

Model learning unit 150 shuffles the data set and then divides the data set for each batch size (that is, B), and performs processing on each of the divided data sets. Model learning unit 150 creates input data for learning based on the data types of the variables described in the variable explanation data. In addition, model learning unit 150 creates a random learning input mask based on the step order data. Furthermore, model learning unit 150 sets randomly selected data as a learning target, partially masks the input data for learning with the learning input mask, and inputs the input data for learning to the model stored in the model storage unit 130. Then, for the data selected as the learning target, model learning unit 150 compares the data inferred and output by the model with the data previously selected as the learning target using a loss function, and updates a parameter of the model so that both the data approach each other. Note that details of the processing of model learning unit 150 will be described later.

Inference unit 160 intentionally applies the mask to all or a part of the data set stored in accumulation unit 120 and inputs all or the part of the data set to the machine learning model stored in model storage unit 130. In addition, inference unit 160 outputs data inferred and output by the machine learning model by inputting all or the part of the data set to the machine learning model, and a degree of contribution of each piece of the data to the data.

### Learning processing procedure

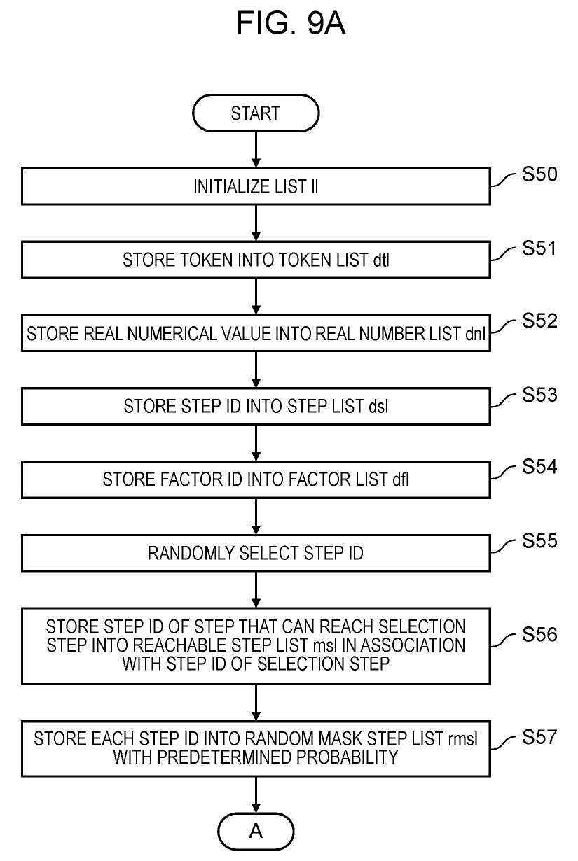

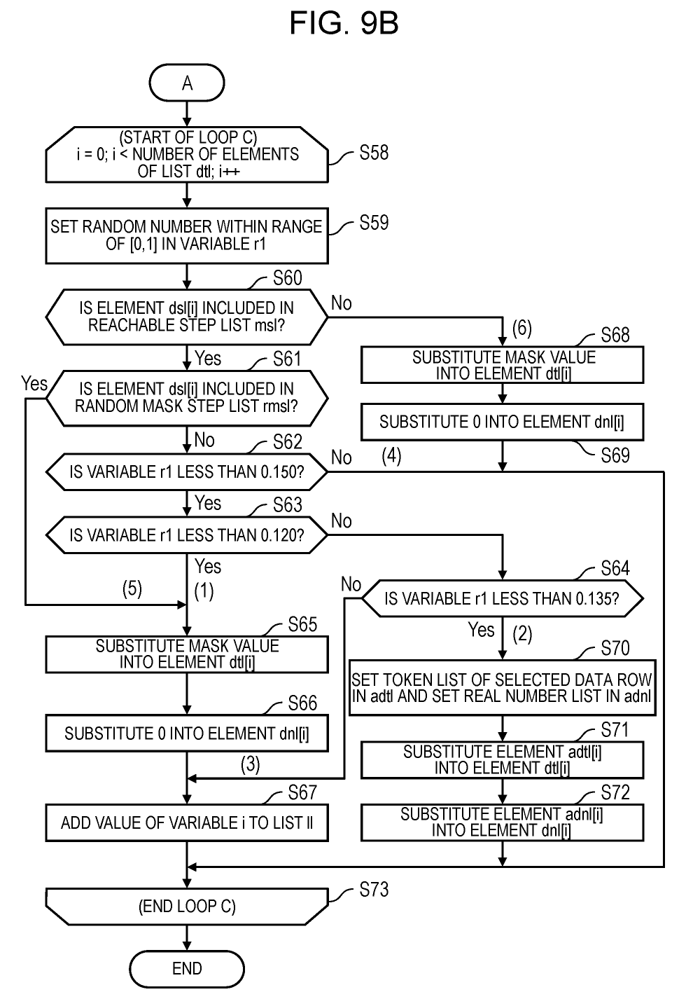

FIG. 8 is a flowchart illustrating processing of data analysis device 1 according to the present exemplary embodiment. FIGS. 9A and 9B are flowcharts illustrating processing of creating input data for learning and selecting a learning target in the present exemplary embodiment. With reference to FIGS. 8, 9A, and 9B, a learning processing procedure in the present exemplary embodiment will be described.

In step S10, acquisition unit 110 acquires the performance data (see FIG. 3), the step order data (see FIG. 4), and the variable explanation data (see FIG. 6), and stores the acquired performance data, step order data, and variable explanation data into accumulation unit 120. The performance data, the step order data, and the variable explanation data correspond to a learning data set. Accumulation unit 120 temporarily stores the performance data, the step order data, and the variable explanation data.

In step S11, preprocessing unit 140 performs preprocessing on the performance data based on the variable explanation data stored in accumulation unit 120, and stores data newly obtained by performing the preprocessing into accumulation unit 120. As one specific example of the preprocessing, preprocessing unit 140 creates data (also referred to as integer value data) in which a unique integer value is assigned to an integer value, a character, and a character string included in the performance data. The integer value is greater than or equal to 2. The integer value data is also referred to as a token.

In this case, in a case where a data loss has occurred in the performance data, preprocessing unit 140 assigns a predetermined value (also referred to as a mask value, and set to 0 in this case) to the loss. Note that the data loss in the performance data can be regarded as a specific value (also referred to as a lost value) present at a corresponding position. In this case, preprocessing unit 140 may assign 0 to the lost value.

In addition, preprocessing unit 140 assigns 1 to data that is not an integer value, a character, or a character string in the performance data. In addition, as specific preprocessing, preprocessing unit 140 creates data in which an item that is included in the performance data and is neither a real numerical value nor a vector is replaced with 0 or 0 vector. Data including the real numerical value and the vector is also referred to as real number data.

In step S12, model learning unit 150 performs processing of starting loop A in which processing in steps S13 to S20 described later is repeatedly executed. In loop A, control is performed such that the processing in steps S13 to S20 is repeatedly executed a sufficient number of times.

Repeatedly executing the processing in steps S13 to S20 a sufficient number of times may be, for example, repeatedly executing the processing in steps S13 to S20 a predetermined number of times as the number of times a change (described later) in the loss function or a change (described later) in the parameter of the model becomes sufficiently small. In addition, repeatedly executing the processing in steps S13 to S20 a sufficient number of times may be, for example, repeatedly executing the processing in steps S13 to S20 until model learning unit 150 determines that a change (described later) in the loss function becomes sufficiently small.

In step S13, model learning unit 150 randomly shuffles the order of the performance data stored in accumulation unit 120, and divides the performance data for each number set as the batch size. The performance data divided for each batch size is referred to as a batch.

In step S14, model learning unit 150 performs processing of starting loop B in which processing in steps S15 to S19 described later is repeatedly executed. In loop B, focusing on each of the batches of the performance data divided in step S13, control is performed such that processing using the focused batch is executed and that processing using all the batches is finally performed. The batch being focused on is also referred to as a focused batch. In addition, processing in steps S15 to S19 included in loop B may be sequentially performed for each of the focused batches, or may be simultaneously performed in parallel for a plurality of focused batches.

In step S15, model learning unit 150 executes processing of creating input data for learning and processing of selecting a learning target for the focused batch. The learning target is a variable to be minimized as an error in step S17.

In step S15, model learning unit 150 creates token list dtl, real number list dnl, step list dsl, and factor list dfl as the input data for learning. The token list is a list of integer value data (that is, tokens) included in a data row included in the focused batch, and has the same number of integer values as the number of tokens arranged in the same order as the tokens included in the data row. The real number list is a list of real numerical values or vectors that are real number data included in the data row included in the focused batch, and has the same number of real numerical values or vectors as the number of real numerical values or vectors included in the data row. The step list is a list of unique step names described in the performance data or the variable explanation data. The factor list is a list of unique variable names described in the performance data or the variable explanation data. In addition, model learning unit 150 creates learning target list ll that is a list indicating a learning target. Specific processing included in step S15 will be described later.

In step S16, inference unit 160 infers the data using the model stored in model storage unit 130. Specifically, inference unit 160 inputs token list dtl, real number list dnl, step list dsl, and factor list dfl created in step S15 to the model stored in model storage unit 130, and acquires data (that is, an inference value of the data) output by the model by forward propagation based on the input and a degree of contribution of each piece of the data to the inference value of the data.

In step S17, model learning unit 150 compares a token indicated in learning target list ll among the data included in the focused batch with the inference value acquired in step S16 as the token indicated in the learning target list ll, and calculates the magnitude of the difference between the token and the inference value as a loss Lt. The magnitude of the difference is sufficient as long as the magnitude is a distance between the token and the inference value, and a cross entropy may be used or an LP norm may be used. In addition, model learning unit 150 compares the token indicated in learning target list ll among tokens included in the focused batch with the inference value acquired in step S16 as the token indicated in the learning target list ll, and calculates the magnitude of the difference between the token and the inference value as a loss Ld. The magnitude of the difference is sufficient as long as the magnitude is a distance between the token and the inference value, and the LP norm may be used, or a weighted sum of a plurality of different LP norms may be used. Thereafter, model learning unit 150 obtains a weighted sum of the loss Lt and the loss Ld as a loss L.

In step S18, model learning unit 150 calculates the gradient of the parameter included in the model by backpropagation using gradient data recorded in the model at the time of the forward propagation in step S16 and the loss L calculated in step S17. The gradient of the parameter included in the model can be calculated by, for example, error backpropagation.

In step S19, model learning unit 150 updates the parameter of the model using the loss calculated in step S17 and the gradient calculated in step S18. The updating method may be an evolutionary algorithm or a gradient method using an error backpropagation method. Note that, in a case where the processing in steps S15 to S19 is performed on a plurality of focused batches in parallel at the same time, in step S19, the sum or average of losses for each focused batch calculated in parallel at the same time can be used as the loss.

In step S20, model learning unit 150 performs processing of ending loop B. Specifically, model learning unit 150 determines whether the processing in steps S15 to S19 has been executed on all the batches. In a case where the processing has not been executed on all the batches, model learning unit 150 performs control to execute the processing while focusing on a batch that has not been executed yet.

In step S21, model learning unit 150 performs processing of ending loop A. Specifically, model learning unit 150 determines whether the processing in steps S13 to S20 has been repeatedly executed a sufficient number of times, and performs control to repeatedly execute the processing a sufficient number of times in a case where the processing has not been executed the sufficient number of times.

### Processing of creating input data for learning and processing of selecting learning target in step S15

Processing of creating input data for learning and processing of selecting a learning target according to the present exemplary embodiment will be described with reference to FIGS. 9A and 9B. The processing illustrated in FIGS. 9A and 9B is the processing included in step S15 illustrated in FIG. 8.

Model learning unit 150 executes the following processing on each data row included in the focused batch.

In step S50 (see FIG. 9A), model learning unit 150 initializes learning target list ll. The initialization of learning target list ll is setting of the state of learning target list ll to indicate that a variable to be learned is not present.

In step S51, model learning unit 150 stores integer value data included in the data row included in the focused batch into token list dtl.

In step S52, model learning unit 150 stores real number data included in the data row included in the focused batch into real number list dnl.

In step S53, model learning unit 150 stores a step ID into step list dsl. As the step ID, an integer value uniquely indicating a step name included in the performance data (for example, data set Ds (see FIG. 3)) or an integer value uniquely indicating a unique step name included in the variable explanation data (see FIG. 6) can be used.

In step S54, model learning unit 150 stores a factor ID into factor list dfl. As the factor ID, an integer value uniquely indicating a variable name included in the performance data (for example, data set Ds (see FIG. 3)) or an integer value uniquely indicating a unique variable name included in the variable explanation data (see FIG. 6) can be used.

In step S55, model learning unit 150 randomly selects one step ID from the plurality of step IDs. Model learning unit 150 substitutes the selected step ID into a variable rs. Note that a step indicated by the step ID selected by model learning unit 150 is also referred to as a selection step.

In step S56, model learning unit 150 stores a step ID of a step capable of reaching the selection step into reachable step list msl in association with the step ID of the selection step. Steps that can reach the selection step are all steps that are performed before the selection step, in other words, the steps do not include a step that is performed after the selection step. The step ID of the step that can reach the selection step can be acquired using step order data Do (see FIG. 4) stored in accumulation unit 120. Specifically, for example, in a case where the selection step is step d, steps that can reach step d that is the selection step are steps a, b, and c.

In step S57, model learning unit 150 stores each step ID into random mask step list rmsl with a predetermined probability (for example, 5%). Random mask step list rmsl is used to set data of a randomly selected step as noise for learning. The addition of the noise can have an effect of suppressing over-learning of the machine learning model, for example.

In step S58 (see FIG. 9B), model learning unit 150 performs processing of starting loop C in which processing in steps S59 to S72 described later is repeatedly executed. In loop C, at least a part of the processing in steps S59 to S72 is controlled to be repeatedly executed the same number of times as the number of pieces of data included in the performance data (that is, the number of tokens included in the token list). Note that variable i indicating the number of repetitions of execution is used. Variable i is 0 in the first execution and is incremented by 1 each time the execution is repeated.

In step S59, model learning unit 150 generates a random number within a range from 0 to 1 inclusive, and substitutes the random number into variable r1. Variable r1 is used to stochastically select one processing pattern from a plurality of processing patterns as a subsequent processing pattern.

In step S60, model learning unit 150 determines whether element dsl[i] is included in reachable step list msl. If model learning unit 150 determines that element dsl[i] is included in reachable step list msl (Yes in step S60), the processing proceeds to step S61, and otherwise (No in step S60), the processing proceeds to step S68.

In step S61, model learning unit 150 determines whether element dsl[i] is included in random mask step list rmsl. If model learning unit 150 determines that element dsl[i] is included in random mask step list rmsl (Yes in step S61), the processing proceeds to step S65, and otherwise (No in step S61), the processing proceeds to step S62.

In step S62, model learning unit 150 determines whether variable r1 is less than 0.150. If model learning unit 150 determines that variable r1 is less than 0.150 (Yes in step S62), the processing proceeds to step S63, and otherwise (No in step S62), the processing proceeds to step S73.

In step S63, model learning unit 150 determines whether variable r1 is less than 0.120. If model learning unit 150 determines that variable r1 is less than 0.120 (Yes in step S63), the processing proceeds to step S65, and otherwise (No in step S63), the processing proceeds to step S64.

In step S64, model learning unit 150 determines whether variable r1 is less than 0.135. If model learning unit 150 determines that variable r1 is less than 0.135 (Yes in step S64), the processing proceeds to step S70, and otherwise (No in step S64), the processing proceeds to step S67.

In other words, in steps S60 to S64, model learning unit 150 branches the processing to one of the subsequent processing patterns. In the subsequent processing patterns, specifically, the processing is branched according to the following conditions (1) to (6). In the following description, element dsl[i] means the i-th element of step list dsl. The same applies to elements of the other lists (for example, token list dtl, real number list dnl, alternative token list adtl, and alternative real number list adnl).

(1) A case where element dsl[i] is included in reachable step list msl, element dsl[i] is not included in random mask step list rmsl, and variable r1 is less than 0.120.

(2) A case where element dsl[i] is included in reachable step list msl, element dsl[i] is not included in random mask step list rmsl, and variable r1 is greater than or equal to 0.120 and less than 0.135.

(3) A case where element dsl[i] is included in reachable step list msl, element dsl[i] is not included in random mask step list rmsl, and variable r1 is greater than or equal to 0.135 and less than 0.150.

(4) A case where element dsl[i] is included in reachable step list msl, element dsl[i] is not included in random mask step list rmsl, and variable r1 is greater than or equal to 0.150.

(5) A case where element dsl[i] is included in reachable step list msl and element dsl[i] is included in random mask step list rmsl.

(6) A case where i-th element dsl[i] of step list dsl is not included in reachable step list msl.

In the case of (1) or (5), model learning unit 150 executes the processing in steps S65 to S67. In the processing in steps S65 to S67, model learning unit 150 performs processing of masking data and setting the masked data as a learning target.

Specifically, model learning unit 150 performs processing of substituting 0 as a mask value representing a lost value in the performance data into i-th element dtl[i] of the token list (step S65), processing of substituting 0 into i-th element dnl[i] of the real number list (step S66), and processing of adding the value of variable i to learning target list ll (step S67). Thereafter, the processing proceeds to step S73.

In the case of (2), model learning unit 150 executes the processing in steps S70 to S72. In the processing in steps S70 to S72, model learning unit 150 performs replacement processing using a randomly selected data row included in the batch as noise. The addition of the noise can have an effect of suppressing over-learning of the machine learning model, for example.

Specifically, model learning unit 150 executes processing of selecting a random data row from a plurality of data rows included in data set Ds and substituting a list of tokens included in the selected data row into alternative token list adtl, processing of substituting a list (real number list) of real numerical values or vectors of real number data included in the data row into alternative real number list adnl (step S70), processing of substituting element adtl[i] into element dtl[i] (step S71), and processing of substituting element adnl[i] into element dnl[i] (step S72). Thereafter, the processing proceeds to step S73.

In the case of (3), model learning unit 150 executes the processing in steps S67. In the processing in step S67, processing of setting data as a learning target is executed. Specifically, model learning unit 150 executes processing of adding the value of variable i to learning target list ll. Thereafter, the processing proceeds to step S73.

In the case of (4), the processing proceeds to step S73. In this case, model learning unit 150 does not execute processing using i-th element dtl[i] of the token list, i-th element dnl[i] of the real number list, or the like.

In the case of (6), model learning unit 150 executes the processing in steps S68 and S69. In the processing in steps S68 to S69, processing of masking data is executed. The processing in steps S68 and S69 is different from the processing in steps S65 to S67 in that the processing of setting the masked data as a learning target is not executed.

Specifically, model learning unit 150 performs processing of substituting 0 as a mask value representing a lost value in the performance data into i-th element dtl[i] of the token list (step S68) and processing of substituting 0 into i-th element dnl[i] of the real number list (step S69). Thereafter, the processing proceeds to step S73.

In step S73, model learning unit 150 performs processing of ending loop C. Specifically, model learning unit 150 determines whether at least a part of the processing in steps S59 to S72 has been repeatedly executed the same number of times as the number of variables included in the performance data (that is, the number of tokens included in the token list), and performs control to execute the processing corresponding to the number of times in a case where the processing corresponding to the number of times is not executed.

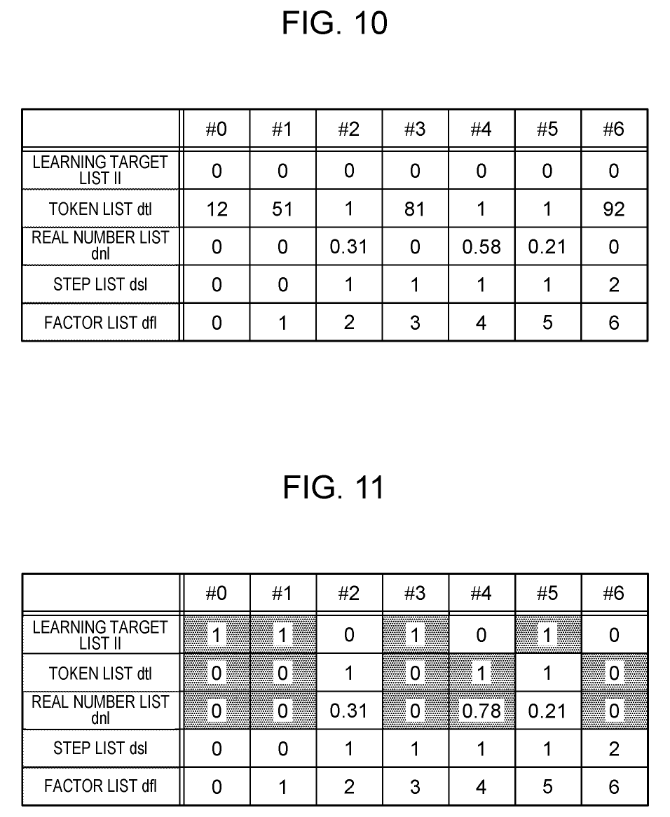

The processing of creating input data for learning and the processing of selecting a learning target (see step S15 illustrated FIG. 8, and FIGS. 9A and 9B), which are executed by model learning unit 150, will be described below with reference to a specific list (FIGS. 10 to 12).

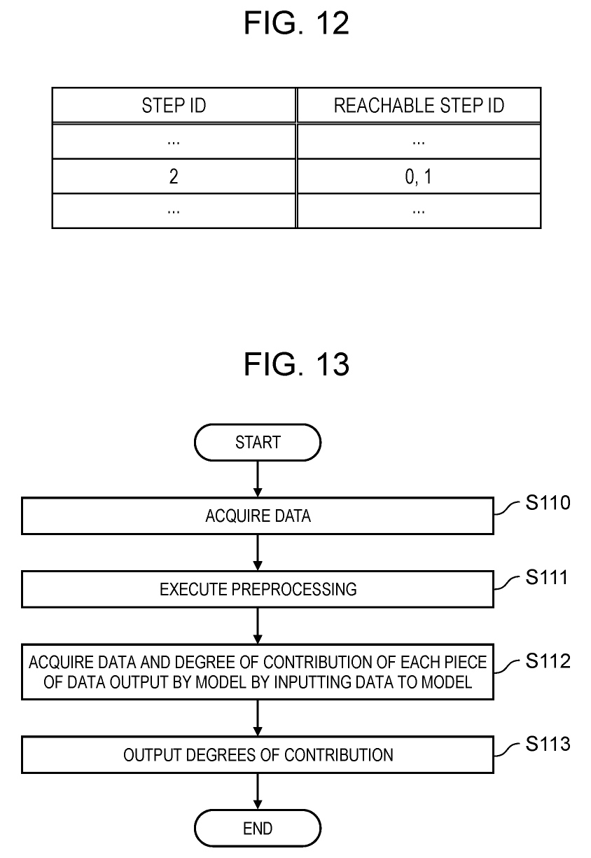

FIGS. 10 and 11 are explanatory diagrams illustrating an example of lists (specifically, the learning target list, the token list, the real number list, the step list, and the factor list) in the present exemplary embodiment. FIG. 12 is an explanatory diagram illustrating an example of the reachable step list in the present exemplary embodiment.

FIG. 10 illustrates a list before the above-described processing is performed, and FIG. 11 illustrates a list after the above-described processing is performed.

FIG. 10 illustrates the contents of learning target list ll, token list dtl, real number list dnl, step list dsl, and factor list dfl corresponding to each of seven pieces of data (data #0, #1,..., and #6) as an example of data included in a data row to be processed.

Learning target list ll indicates data selected as a learning target by main update processing (that is, a series of processing illustrated in FIG. 8 executed for a main update) among data (corresponding to a variable in which “whether to be set as a learning target” indicates Yes in FIG. 6) to be set as a learning target as entire learning processing by data analysis device 1. Specifically, it is illustrated that data of which an element is 1 in learning target list ll is data selected as a learning target, and data of which an element is 0 in learning target list ll is data not selected as a learning target. Learning target list ll illustrated in FIG. 10 indicates that all elements are 0 and all data #0 to #6 are not selected as learning targets.

Token list dtl indicates a token corresponding to the data included in the data row to be processed. Token list dtl illustrated in FIG. 10 indicates that a token corresponding to data #0 is 12. This corresponds to, for example, a case where data #0 is an integer value of 12. In addition, it is illustrated that a token corresponding to data #2 is 1. This corresponds to, for example, a case where data #2 is real number data.

Real number list dnl indicates a real numerical value included in the data row to be processed. Real number list dnl illustrated in FIG. 10 indicates that a real number corresponding to data #2 is 0.31. This corresponds to, for example, a case where data #2 is a real numerical value of 0.31, and in this case, the token corresponding to data #2 in token list dtl is 1.

Step list dsl indicates a step ID of a step in which the data included in the data row to be processed is obtained. Step list dsl illustrated in FIG. 10 indicates that a step ID of a step in which data #0 and #1 are obtained is 0. Further, it is shown that a step ID of a step in which each of data #2 to #5 is obtained is 1.

Factor list dfl indicates a numerical value as an identifier corresponding to a data name of the data included in the data row to be processed. For example, factor list dfl illustrated in FIG. 10 indicates that a numerical value corresponding to a data name of data #0 is 0 and a numerical value corresponding to a data name of data #1 is 1. Note that 0 and 1 as data names correspond to, for example, variables A and B illustrated in FIG. 6, respectively. The same applies to numerical values as other data names.

The processing of creating input data for learning and the processing of selecting a learning target are executed on each of data #0 to #6 illustrated in FIG. 10, and as a result, each list is in a state illustrated in FIG. 11. Note that, in FIG. 11, data changed by the above-described processing is indicated by shading in a frame including the data.

In this case, a case where model learning unit 150 selects 2 as the step ID in step S55 will be described as an example. In addition, in this case, it is assumed that a step with a step ID of 0 and a step with a step ID of 1 can reach a step with a step ID of 2. In this case, in step S56, model learning unit 150 stores 0 and 1 as the step IDs of the steps that can reach the step with the step ID of 2 into reachable step list msl in association with 2 as the step ID (see FIG. 12).

In addition, a case where model learning unit 150 stores 0 as a step ID in random mask step list rmsl and does not store another step ID in random mask step list rmsl in step S57 will be described as an example.

First, in step S58, variable i is set to 0, and processing on data #0 is executed. In this case, since 0 that is element dsl[0] is included in reachable step list msl and 0 that is element dsl[0] is included in random mask step list rmsl, the condition (5) is satisfied, and the processing in steps S65 to S67 is executed. As a result, a token (that is, element dtl[0]) corresponding to data #1 is changed to 0 which is a mask value, and a real numerical value (that is, element dnl[0]) corresponding to data #1 is changed to 0. In addition, data #0 is changed to a learning target.

Next, in step S58, variable i is set to 1, and processing on data #1 is executed. In this case, since 0 that is element dsl[1] is included in reachable step list msl and 0 that is element dsl[1] is included in random mask step list rmsl, the condition (5) is satisfied, and the processing in steps S65 to S67 is executed. As a result, the token (that is, element dtl[1]) corresponding to data #1 is changed to 0 which is a mask value, and a real numerical value (that is, element dnl[1]) corresponding to data #1 is changed to 0. In addition, data #1 is changed to a learning target.

Next, in step S58, variable i is set to 2, and processing on data #2 is executed. In this case, 1 that is element dsl[2] is included in reachable step list msl, and 1 that is element dsl[2] is not included in random mask step list rmsl. In this case, it is assumed that a random number value (for example, 0.30) that is greater than or equal to 0.150 is set in variable r1 in step S59. In this case, the condition (4) is satisfied, and the elements of the list are not changed.

Next, in step S58, variable i is set to 3, and processing on data #3 is executed. In this case, 1 that is element dsl[3] is included in reachable step list msl, and 1 that is element dsl[3] is not included in random mask step list rmsl. In this case, it is assumed that a random number value (for example, 0.100) that is less than 0.120 is set in variable r1 in step S59. In this case, the condition (1) is satisfied, and the processing in steps S65 to S67 is executed. As a result, a token (that is, element dtl[3]) corresponding to data #3 is changed to 0 which is a mask value, and a real numerical value (that is, element dnl[3]) corresponding to data #3 is changed to 0. In addition, data #3 is changed to a learning target.

Next, in step S58, variable i is set to 4, and processing on data #4 is executed. In this case, 1 that is element dsl[4] is included in reachable step list msl and 1 that is element dsl[4] is not included in random mask step list rmsl. In this time, it is assumed that a random number value (for example, 0.130) that is greater than or equal to 0.120 and less than 0.135 is set in variable r1 in step S59. In this case, the condition (2) is satisfied, and the processing in steps S70 to S72 is executed. As a result, a token (that is, element dtl [4]) corresponding to data #4 is changed to 1, and a real numerical value corresponding to data #4 (that is, element dnl[4]) is changed to 0.78.

Next, in step S58, variable i is set to 5, and processing on data #5 is executed. In this case, 1 that is element dsl[5] is included in reachable step list msl, and 1 that is element dsl[5] is not included in random mask step list rmsl. In this case, it is assumed that a random number value (for example, 0.140) that is greater than or equal to 0.135 and less than 0.150 is set in variable r1 in step S59. In this case, the condition (3) is satisfied, and the processing in step S67 is executed. As a result, data #5 is changed to a learning target.

Next, in step S58, variable i is set to 6, and processing on data #6 is executed. In this case, 2 that is element dsl[6] is not included in reachable step list msl. In this case, the condition (6) is satisfied, and the processing in steps S68 and S69 is executed. As a result, a token (that is, element dtl[6]) corresponding to data #6 is changed to 0 which is a mask value, and a real numerical value (that is, element dnl[6]) corresponding to data #6 is changed to 0.

As described above, the lists (specifically, the learning target list, the token list, the real number list, the step list, and the factor list) illustrated in FIG. 11 are obtained.

Next, data analysis processing executed by data analysis device 1 according to the present exemplary embodiment will be described.

Data analysis device 1 acquires a data row including a plurality of pieces of data that are regarding a product and obtained in a plurality of steps in manufacturing of the product, sets target data among the plurality of pieces of acquired data as an inference target, acquires inference data output by inputting a plurality of pieces of data to an inference model, and a degree of contribution of each of the plurality of pieces of data to the inference data, and outputs the degree of contribution of each of the plurality of pieces of acquired data. In this case, the inference model is a learned model trained to set, as an inference target, learning target data among a plurality of pieces of learning data included in each of a plurality of learning data rows, output the learning target data inferred from one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

The inference model may be a machine learning model using an attention mechanism. Then, the degree of contribution of each of the plurality of pieces of data to the inference data may be a weight of each of the plurality of pieces of data for the inference data and output by the attention mechanism.

Note that the analysis processing can be executed using acquisition unit 110, accumulation unit 120, model storage unit 130, and inference unit 160 among the components included in data analysis device 1. Therefore, a device including at least acquisition unit 110, accumulation unit 120, model storage unit 130, and inference unit 160 can be used as data analysis device 1 that performs the analysis processing.

FIG. 13 is a flowchart illustrating the data analysis processing according to the present exemplary embodiment.

In step S110, acquisition unit 110 acquires a data row including a plurality of pieces of data obtained in a step in manufacturing a product. In addition, acquisition unit 110 acquires step order data (see FIG. 4) and variable explanation data (see FIG. 6). Acquisition unit 110 stores the acquired data row, step order data, and variable explanation data into accumulation unit 120. Accumulation unit 120 temporarily stores performance data, the step order data, and the variable explanation data.

In step S111, preprocessing unit 140 performs preprocessing on the data row based on the variable explanation data stored in accumulation unit 120, and stores data row newly obtained by performing the preprocessing into accumulation unit 120. The preprocessing is similar to the preprocessing described with reference to step S11.

In step S112, inference unit 160 infers data using the model stored in model storage unit 130, and acquires the inferred data and a degree of contribution of each of the pieces of data to the inferred data.

In step S113, inference unit 160 outputs the degrees of contribution acquired in step S112.

Through the series of processing illustrated in FIG. 13, data analysis device 1 can output the degree of contribution of each piece of the data to data among the plurality of pieces of data obtained in the step in the manufacturing of the product. In addition, data analysis device 1 can improve the efficiency of learning for inference for outputting the degrees of contribution.

In the above-described exemplary embodiment, each of the components may be implemented by dedicated hardware, or implemented by executing a software program suitable for the component. Each of the components may be implemented by a program execution unit such as a CPU or a processor reading and executing a software program recorded in a recording medium such as a hard disk or a semiconductor memory. Here, the software that implements the information processing device and the like according to the above-described exemplary embodiment is the following program.

The program causes an information processing method to be executed, the information processing method including: acquiring a data row including a plurality of pieces of data that are regarding a product and obtained in a plurality of steps in manufacturing of the product; setting target data among the plurality of pieces of acquired data as an inference target, and acquiring inference data output by inputting the plurality of pieces of data to an inference model, and a degree of contribution of each of the plurality of pieces of data to the inference data; and outputting the degree of contribution of each of the plurality of pieces of acquired data, wherein the inference model is a learned model trained to set, as an inference target, learning target data among a plurality of pieces of learning data included in each of a plurality of learning data rows, output the learning target data inferred from one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

In addition, the program causes an information processing method to be executed, the information processing method including: acquiring a plurality of learning data rows including a plurality of pieces of learning data that are regarding a product and obtained in a plurality of steps in manufacturing of the product; and training an inference model using the plurality of acquired learning data rows, wherein in the training of the inference model, the inference model is trained to set, as an inference target, learning target data among a plurality of pieces of learning data included in each of the plurality of learning data rows, infer the learning target data from one or more pieces of learning data obtained in a step upstream of a step in which the learning target data is obtained, and infer a degree of contribution of each of the one or more pieces of learning data to the learning target data to be inferred.

Although the information processing method and the like according to one or a plurality of aspects have been described above based on the exemplary embodiment, the present disclosure is not limited to the exemplary embodiment. Configurations in which various modifications conceivable by those skilled in the art are applied to the present exemplary embodiment and configurations constructed by combining components in different exemplary embodiments may also be included in the scope of one or more aspects without departing from the gist of the present disclosure.

### INDUSTRIAL APPLICABILITY

The present disclosure can be used for an apparatus that performs analysis to specify a variable in a step of manufacturing a product.

### REFERENCE MARKS IN THE DRAWINGS

1 data analysis device

101 input unit

102 arithmetic circuit

103 memory

104 output unit

105 storage

105a program

105b temporary data

106 database

107 communication unit

110 acquisition unit

120 accumulation unit

130 model storage unit

140 preprocessing unit

150 model learning unit

160 inference unit

500 manufacturing management device

900 data analysis system

Ds data set

1. An information processing method comprising:
acquiring a data row including a plurality of pieces of data that are regarding a product and obtained in a plurality of steps in manufacturing of the product;
setting target data among the plurality of pieces of acquired data as an inference target, and acquiring inference data output by inputting the plurality of pieces of data to an inference model, and a degree of contribution of each of the plurality of pieces of data to the inference data; and
outputting the degree of contribution of each of the plurality of pieces of acquired data, wherein the inference model is a learned model trained to set, as an inference target, learning target data among a plurality of pieces of learning data included in each of a plurality of learning data rows, output the learning target data inferred from one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

2. The information processing method according to claim 1, wherein
the inference model is a machine learning model using an attention mechanism, and
the degree of contribution of each of the plurality of pieces of data to the inference data is a weight of each of the plurality of pieces of data for the inference data and is output by the attention mechanism.

3. An information processing method comprising:
acquiring a plurality of learning data rows including a plurality of pieces of learning data that are regarding a product and obtained in a plurality of steps in manufacturing of the product; and
training an inference model using the plurality of acquired learning data rows,
wherein in the training of the inference model, the inference model is trained to set, as an inference target, learning target data among a plurality of pieces of learning data included in each of the plurality of learning data rows, infer the learning target data from one or more pieces of learning data obtained in a step upstream of a step in which the learning target data is obtained, and infer a degree of contribution of each of the one or more pieces of learning data to the learning target data to be inferred.

4. The information processing method according to claim 3, wherein
the plurality of learning data rows include an identifier of the step in which each of the plurality of pieces of learning data is obtained, and
in the training of the inference model,
the one or more pieces of learning data are specified by using order information indicating an order of the plurality of steps to exclude (a) a step in which the learning target data is obtained among the plurality of pieces of learning data and (b) a step downstream of the step in which the learning target data is obtained, and the inference model is trained using the specified one or more pieces of learning data.

5. The information processing method according to claim 3, wherein
the inference model is a machine learning model using an attention mechanism, and
the degree of contribution of each of the one or more pieces of learning data to the learning target data to be inferred is a weight of each of the plurality of pieces of learning data for the learning target data to be inferred and is output by the attention mechanism.

6. An information processing device comprising:
an acquisition unit that acquires a data row including a plurality of pieces of data that are regarding a product and obtained in a plurality of steps in manufacturing of the product; and
an inference unit that sets target data among the plurality of pieces of acquired data as an inference target, acquires inference data output by inputting the plurality of pieces of data to an inference model, and a degree of contribution of each of the plurality of pieces of data to the inference data, and outputs the degree of contribution of each of the plurality of pieces of acquired data,
wherein the inference model is a learned model trained to use, as an inference target, learning target data among a plurality of pieces of learning data included in each of a plurality of learning data rows, output the learning target data by inputting one or more pieces of learning data obtained in a step upstream of a step in which the learning target data is obtained, and output a degree of contribution of each of the one or more pieces of learning data to the learning target data to be output, when the plurality of learning data rows regarding the product in the plurality of steps are input to the inference model.

7. An information processing device comprising:
an acquisition unit that acquires a plurality of learning data rows including a plurality of pieces of learning data that are regarding a product and obtained in a plurality of steps in manufacturing of the product; and
a learning unit that trains an inference model using the plurality of acquired learning data rows regarding the product in the plurality of steps,
wherein in the training of the inference model, the learning unit trains the inference model to set, as an inference target, learning target data among a plurality of pieces of learning data included in each of the plurality of learning data rows, and infer the learning target data and infer a degree of contribution of each of the one or more pieces of learning data to the learning target data to be inferred, when one or more pieces of learning data obtained in a step upstream of a step in which the learning target data is obtained are input to the inference model.

8. A program for causing a computer to execute the information processing method according to claim 1.

9. A program for causing a computer to execute the information processing method according to claim 3.
